(19) United States
(12) Patent Application Publication
(10) Pub. No.: US 2018/0362698 A1
(43) Pub. Date: Dec. 20, 2018

(54) PROTECTIVE MEMBER FOR COIL SPRINGS AND METHOD OF MANUFACTURING THE SAME

(71) Applicants: SUNG RHIM T&T CO., LTD., Daegu (KR); YOUNGHEUNG IRON & STEEL. CO. LTD., Boryeong-si (KR)

(72) Inventors: Chil Seok Joo, Daegu (KR); Jung Ki Choi, Buk-gu (KR)

(73) Assignees: SUNG RHIM T&T CO., LTD., Daegu (KR); YOUNGHEUNG IRON & STEEL. CO. LTD., Boryeong-si (KR)

(21) Appl. No.: 15/625,607

(22) Filed: Jun. 16, 2017

(51) Int. Cl. C08G 18/10; C08G 18/76; C08G 18/42; C08J 3/12; C08K 3/04; C08J 5/00; F16F 1/02

(52) U.S. Cl. CPC C08G 18/10; C08G 18/7671; C08G 18/42; C08J 3/12; B60G 2204/4308; C08J 5/00; F16F 1/024; C08J 2375/06; C08K 3/041

(57) ABSTRACT

Provided is a protective member for coil springs, including a tube main body that covers a coil spring of a suspension, wherein the tube main body is made of thermoplastic polyurethane that includes a prepolymer and a chain extender, wherein the prepolymer includes diisocyanate and a polyol, wherein a molar ratio of the diisocyanate to a sum of the polyol and the chain extender (diisocyanate/(polyol+chain extender)) is 1.025 to 1.040 and a molar ratio of the chain extender to the polyol (chain extender/polyol) is 6 to 3.8.

### BACKGROUND

### 1. Field of the Invention

The present disclosure relates to a protective member for coil springs and a method of manufacturing the same, and more particularly, to a protective member for covering a coil spring of a suspension mounted in various vehicles to protect the coil spring and a method of manufacturing the same.

### 2. Discussion of Related Art

A coil spring or the like, which is mounted as a suspension device in various vehicles including automobiles or construction equipment, can protect an automobile body by absorbing shock due to driving of the automobile and improve riding comfort for an occupant.

Meanwhile, if foreign matter, such as soil, sand, or gravel, impacts a coil spring during operation of a vehicle, a surface of a coil spring coated with paint may be damaged, which causes oxidation. In addition, a coil spring may be rusted or corroded due to calcium chloride used for deicing in the winter, and cracks or fractures may occur in the coil spring. To prevent these problems, a countermeasure of covering a coil spring with a protective member has been proposed.

However, since an end portion (cutout portion) of such a protective member is exposed to the outside, foreign matter can easily penetrate a gap between the protective member and the coil spring. When such foreign matter penetration is continued, the elasticity of a protective member is decreased, which causes morphological deformation. Further, a coil spring may be broken due to damage to the protective member.

### SUMMARY OF THE INVENTION

Therefore, the present disclosure has been made in view of the above problems, and it is an objective of the present disclosure to provide a protective member for coil springs which is configured to prevent a cut portion of a tube main body from being exposed to the outside and thus prevents the entry of foreign matter into a gap between the tube main body and a coil spring.

It is another object of the present disclosure to provide a protective member for coil springs made of thermoplastic polyurethane that provides improved mechanical strength by separately reacting reactants in each step and limiting a composition ratio of the reactants, and a method of manufacturing the protective member.

In accordance with an aspect of the present disclosure, the above and other objects can be accomplished by the provision of a protective member for coil springs, including a tube main body that covers a coil spring of a suspension, wherein the tube main body is composed of a prepolymer and a chain extender, wherein the prepolymer includes diisocyanate and a polyol, wherein a molar ratio of the diisocyanate to a sum of the polyol and the chain extender (diisocyanate(polyol+chain extender)) is 1.025 to 1.040 and a molar ratio of the chain extender to the polyol (chain extender/polyol) is 3.6 to 3.8.

The diisocyanate may be selected from the group consisting of methylene diphenyl diisocyanate (MDI), toluene diisocyanate (TDI), dimethyl diphenyl diisocyanate (TODI), naphthalene diisocyanate (NDI), isophorone diisocyanate (IPDI), phenylene diisocyanate, ethylene diisocyanate, butane diisocyanate, hexane diisocyanate (HDI), cyclohexane diisocyanate, dicyclohexyl methane diisocyanate, and combinations thereof.

The polyol may be selected from the group consisting of polyester polyols, polycarbonate polyols, polyether polyols, and combinations thereof.

The chain extender may be selected from the group consisting of ethylene glycol, propanediol, butanediol, pentanediol, hexanediol, heptanediol, octanediol, decanediol, and combinations thereof.

0.05 to 0.10 parts by weight of carbon nanotubes, relative to 100 parts by weight of a sum of the diisocyanate, the polyol, and the chain extender, may be further included.

The protective member may further include a dual tube for covering the coil spring, wherein a portion of the dual tube covers the tube main body that covers the coil spring, and a remainder of the dual tube covers a portion of the coil spring that is not covered by the tube main body.

The dual tube and the tube main body may be made of an identical material, and a marked part may be formed at a center, in a longitudinal direction, of the dual tube.

The dual tube and the tube main body may be made of an identical material, both ends of the dual tube may have different inner diameters, and a step may be formed at a center, in a longitudinal direction, of the dual tube, and one end of the dual tube having a larger inner diameter may cover the tube main body that covers the coil spring, and another end of the dual tube having a smaller inner diameter may cover the coil spring that is not covered by the tube main body.

An inner diameter of one end of the tube main body may be smaller than an inner diameter of another end of the tube main body, and a ratio of the inner diameter of the end to the inner diameter of the other end may be 1:1.05 to 1:1.25.

In accordance with another aspect of the present disclosure, there is provided a method of manufacturing a protective member for coil springs, the method including preparing a prepolymer by reacting diisocyanate with a polyol; adding a chain extender containing a glycol to the prepolymer and mixing the same; and preparing a paste by reacting a resultant mixture at 80 to 120° C., wherein a molar ratio of the diisocyanate to a sum of the polyol and the chain extender (diisocyanate/(polyol+chain extender)) is 1.025 to 1.040, and a molar ratio of the chain extender to the polyol (chain extender/polyol) is 3.6 to 3.8.

The method may further include, after the preparing of the paste, pulverizing the paste and additionally reacting the pulverized paste in a 200 to 250° C. pelletizing extruder.

The diisocyanate may be selected from the group consisting of methylene diphenyl diisocyanate (MDI), toluene diisocyanate (TDI), dimethyl diphenyl diisocyanate (TODI), naphthalene diisocyanate (NDI), isophorone diisocyanate (IPDI), phenylene diisocyanate, ethylene diisocyanate, butane diisocyanate, hexane diisocyanate (HDI), cyclohexane diisocyanate, dicyclohexyl methane diisocyanate, and combinations thereof.

The polyol may be selected from the group consisting of polyester polyols, polycarbonate polyols, polyether polyols, and combinations thereof.

The chain extender may be selected from the group consisting of ethylene glycol, propanediol, butanediol, pentanediol, hexanediol, heptanediol, octanediol, decanediol, and combinations thereof.

0.05 to 0.10 parts by weight of carbon nanotubes, relative to 100 parts by weight of a sum of the diisocyanate, the polyol, and the chain extender, may be added to the additionally reacted paste.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view illustrating a tube main body and a dual tube, which is separated from the tube main body, of a protective member for coil springs according to an embodiment of the present disclosure;

FIG. 2 illustrates a state in which a dual tube of a protective member for coil springs according to an embodiment of the present disclosure is mounted;

FIG. 3 illustrates a first embodiment of a dual tube of a protective member for coil springs according to an embodiment of the present disclosure;

FIG. 4 illustrates a second embodiment of a dual tube of a protective member for coil springs according to an embodiment of the present disclosure;

FIG. 5 is a perspective view illustrating a tube main body and a dual tube, which is separated from the tube main body, of a protective member for coil springs according to another embodiment of the present disclosure;

FIG. 6 illustrates a state in which a dual tube of a protective member for coil springs according to another embodiment of the present disclosure is mounted;

FIG. 7 illustrates a tube main body of a protective member for coil springs according to another embodiment of the present disclosure;

FIG. 8 illustrates a first embodiment of a dual tube of a protective member for coil springs according to another embodiment of the present;

FIG. 9 illustrates a second embodiment of a dual tube of a protective member for coil springs according to another embodiment of the present disclosure;

FIG. 10 illustrates a first embodiment of a tube main body of a protective member for coil springs according to another embodiment of the present disclosure;

FIG. 11 illustrates a second embodiment of a tube main body of a protective member for coil springs according to another embodiment of the present disclosure;

FIG. 12 illustrates a schematic flowchart of a method of manufacturing a protective member for coil springs according to an embodiment of the present disclosure;

FIG. 13 illustrates a flowchart of a method of manufacturing a protective member for coil springs according to an embodiment of the present disclosure; and

FIG. 14 is a graph illustrating the properties of thermoplastic polyurethane prepared according to each of a comparative example and examples of the present disclosure.

### DETAILED DESCRIPTION OF EXEMPLARY EMBODIMENTS

Embodiments of a protective member for coil springs and a method of manufacturing the same according to the present disclosure will now be described more fully with reference to the accompanying drawings. In the drawings, the thicknesses of lines and the sizes of constituents may be exaggerated for clarity.

In addition, the terms used in the specification are defined in consideration of functions used in the present disclosure, and can be changed according to the intent or conventionally used methods of clients, operators, and users. Accordingly, definitions of the terms should be understood on the basis of the entire description of the present specification.

In the specification, the expression “inner direction” refers to a direction approaching a center of a tube, and the expression “outer direction” refers to a direction retreating from the center of a tube. Similarly, in the specification, the expression “inner diameter” refers to an inner diameter of a tube, and the expression “outer diameter” refers to an outer diameter of a tube. In the specification, the expression “thickness” refers to an absolute value of a difference between the inner diameter and the outer diameter. In addition, in the specification, the expression “inner surface” refers to an inner surface of a tube, and the expression “outer surface” refers to an outer surface of a tube.

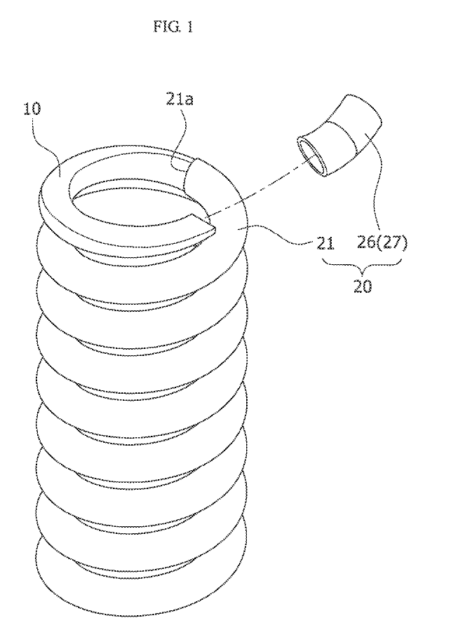

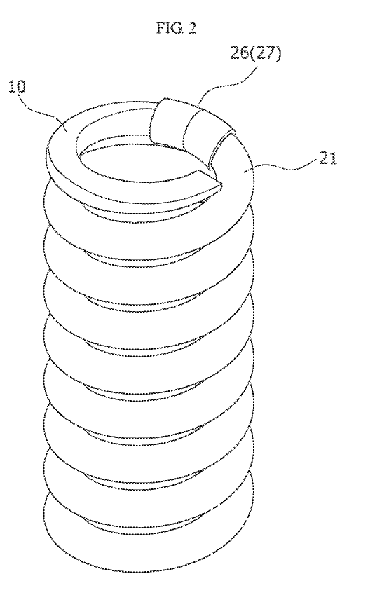

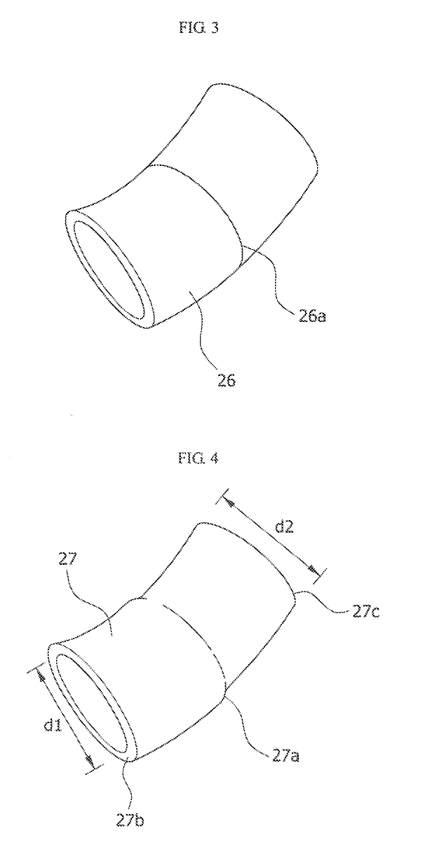

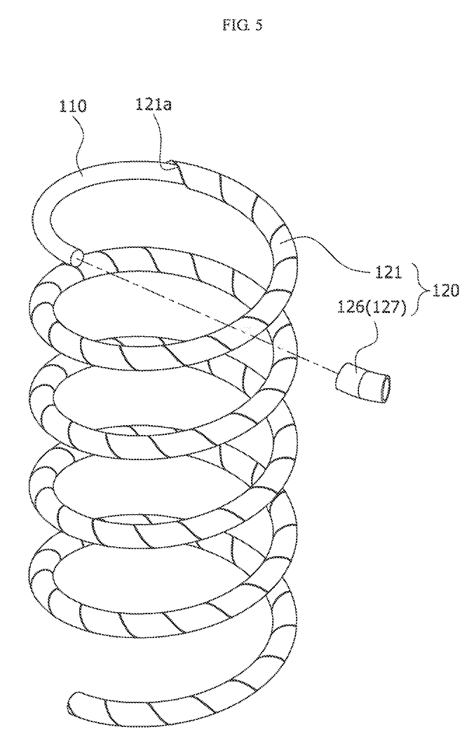

FIG. 1 is a perspective view illustrating a tube main body and a dual tube, which is separated from the tube main body, of a protective member for coil springs according to an embodiment of the present disclosure. FIG. 2 illustrates a state in which a dual tube of a protective member for coil springs according to an embodiment of the present disclosure is mounted. FIG. 3 illustrates a first embodiment of a dual tube of a protective member for coil springs according to an embodiment of the present disclosure. FIG. 4 illustrates a second embodiment of a dual tube of a protective member for coil springs according to an embodiment of the present disclosure.

Referring to FIGS. 1 and 2, a protective member for coil springs 20 according to an embodiment of the present disclosure has a hollow pipe shape. The protective member for coil springs 20 according to this embodiment includes a tube main body 21 and a dual tube 26 (27).

The tube main body 21 has a hollow pipe shape, and surrounds and covers a coil spring 10 of a suspension for various vehicles.

The dual tube 26 (27) covers the coil spring 10. Particularly, a portion of the dual tube 26 (27) covers the tube main body 21 that covers the coil spring 10, and the remainder of the dual tube 26 (27) covers a portion of the coil spring 10 that is not covered by the tube main body 21.

In the embodiment, the end 21a of the tube main body 21 is not exposed to the outside because the end 21a is covered by the dual tube 26 (27). Accordingly, the entry of foreign matter, such as soil and water, into a gap between the end 21a of the tube main body 21 and the coil spring 10 may be prevented.

Since the dual tube 26 (27) is made of a shrinkable material as in the tube main body 21, a portion of the dual tube 26 (27) contacts the tube main body 21, and the remainder of the dual tube 26 (27) contacts the coil spring 10. Accordingly, the entry of foreign matter into a gap between the dual tube 26 (27) and the tube main body 21 or a gap between the dual tube 26 (27) and the coil spring 10 may be prevented.

Referring to FIG. 3, a marked part 26a is formed at the center, in a longitudinal direction, of a dual tube 26 according to an embodiment of the present disclosure. The lengths of left and right portions of the dual tube 26 may be the same with respect to the end 21a of the tube main body 21 merely by aligning the marked part 26a of the dual tube 26 with the end 21a of the tube main body 21 when the dual tube 26 is installed.

Since both sides of the dual tube 26, with respect to the end 21a of the tube main body 21, may be blocked, without being biased toward any side, due to the marked part 26a, the entry of foreign matter into a gap between one end of the dual tube 26 and the tube main body 21 and a gap between the other end of the dual tube 26 and the coil spring 10 may be simultaneously prevented.

Referring to FIG. 4, in another embodiment, ends 27b and 27c of a dual tube 27 have different inner diameters, and a step 27a may be formed at the center of, in a longitudinal direction, the dual tube 27. The end 27b with a larger inner diameter d1 of the dual tube 27 covers the tube main body 21 that covers the coil spring 10, and the end 27c with a smaller inner diameter d2 directly covers the coil spring 10, not the tube main body 21.

Accordingly, the entry of foreign matter into a gap between a left end of the dual tube 27 (see FIG. 4) and the tube main body 21 and a gap between a right end of the dual tube 27 and the coil spring 10 may be simultaneously blocked. Further, in consideration of a thickness difference between a covered portion of the tube main body 21 and a non-covered portion thereof, the dual tube 27 may be more easily installed at the end 21a of the tube main body 21.

The step 27a is formed at the center, in a longitudinal direction, of a dual tube 27. The lengths of left and right portions of the dual tube 27 may be the same with respect to the end 21a of the tube main body 21 merely by aligning the step 27a of the dual tube 27 with the end 21a of the tube main body 21 when the dual tube 27 is installed.

Since both sides of the dual tube 27, with respect to the end 21a of the tube main body 21, may be blocked, without being biased toward any side, due to the step 27a, the entry of foreign matter into a gap between one end of the dual tube 27 and the tube main body 21 and a gap between the other end of the dual tube 27 and the coil spring 10 may be simultaneously prevented.

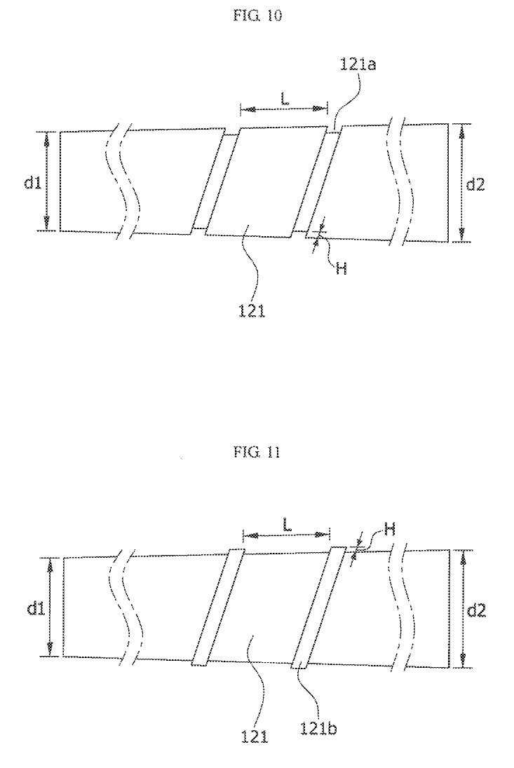

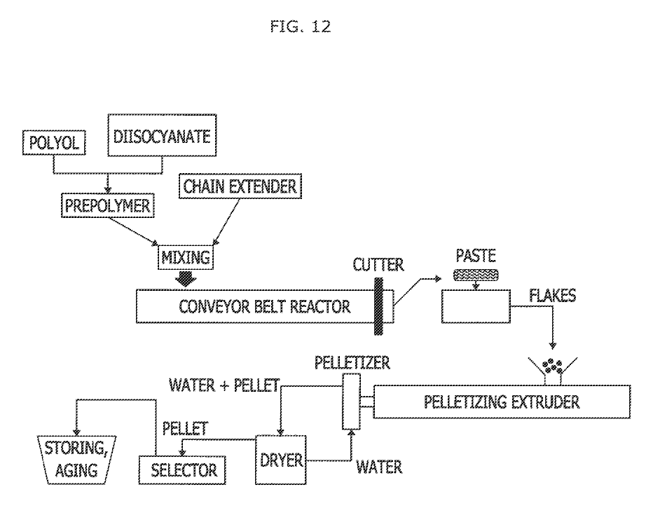

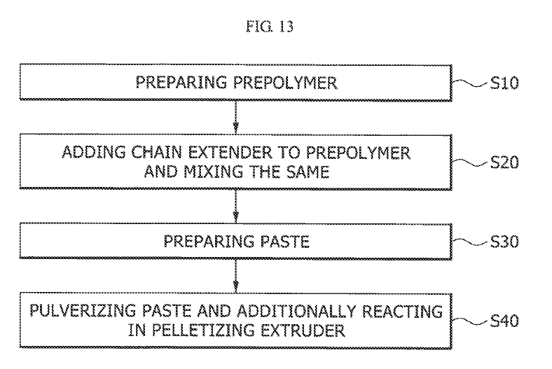

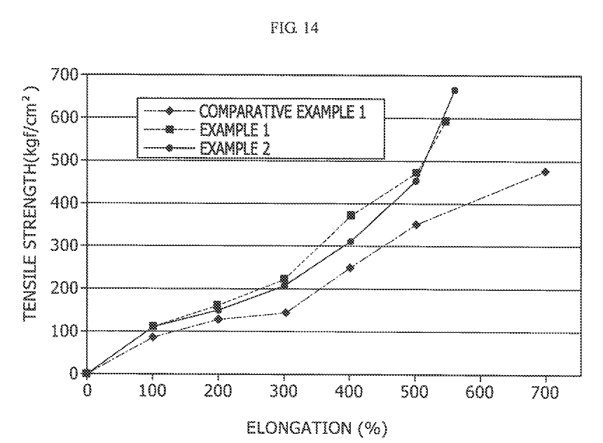

FIG. 10 illustrates a first embodiment of a tube main body of a protective member for coil springs according to another embodiment of the present disclosure. FIG. 11 illustrates a second embodiment of a tube main body of a protective member for coil springs according to another embodiment of the present disclosure. FIG. 12 illustrates a schematic flowchart of a method of manufacturing a protective member for coil springs according to an embodiment of the present disclosure. FIG. 13 illustrates a flowchart of a method of manufacturing a protective member for coil springs according to an embodiment of the present disclosure. FIG. 14 is a graph illustrating the properties of thermoplastic polyurethane prepared according to each of an example and comparative examples of the present disclosure.

Referring to FIGS. 12 and 13, a method of manufacturing a protective member for coil springs of the present disclosure using thermoplastic polyurethane will now be described.

Thermoplastic polyurethane, as a material of the protective member for coil springs 20 of the present disclosure, is classified into a hard segment, which is composed of a diisocyanate and a chain extender, and a soft segment, which is composed of a polyol. Due to the combination of the hard segment and the soft segment, both the elasticity of rubber and the strength of plastic are exhibited.

The properties of the thermoplastic polyurethane may be varied depending upon the type of diisocyanate, chain extender, and polyol constituting the hard segment and the soft segment, and a mixing ratio thereof.

A step of preparing the thermoplastic polyurethane, as a material of the protective member for coil springs 20, may include a step of preparing a prepolymer by reacting polydiisocyanate with a polyol, a step of adding a chain extender containing a glycol to the prepolymer and mixing the same, and a step of preparing a paste by reacting a resultant mixture at 80 to 120° C.

Accordingly, a method of manufacturing the protective member for coil springs 20 according to the present disclosure manufactured from thermoplastic polyurethane also includes a step of preparing a prepolymer by reacting polydiisocyanate with a polyol (S10), a step of adding a chain extender containing a glycol to the prepolymer and mixing the same (S20), and a step of reacting a resultant mixture at 80 to 120° C., to prepare a paste (S30).

in accordance with an embodiment of the present disclosure, a molar ratio of the diisocyanate to the sum of the polyol and the chain extender (diisocyanate/(polyol+chain extender)) is 1.025 to 1.040, and a molar ratio of the chain extender to the polyol (chain extender/polyol) is 3.6 to 3.8.

The prepolymer may be prepared by mixing diisocyanate with a polyol and reacting the same at 80 to 120° C. for 20 to 30 minutes. When this reaction is performed within these temperature and time ranges, reactivity and bonding strength between the diisocyanate and the polyol may be maximized.

The diisocyanate, as a compound containing two —NCO groups therein, binds with an —OH group contained in the chain extender or the polyol to form a urethane bond.

The diisocyanate may be one selected from the group consisting of methylene diphenyl diisocyanate (MDI), toluene diisocyanate (TDI), dimethyl diphenyl diisocyanate (TODI), naphthalene diisocyanate (NDI), isophorone diisocyanate (IPDI), phenylene diisocyanate, ethylene diisocyanate, butane diisocyanate, hexane diisocyanate (HDI), cyclohexane diisocyanate, dicyclohexyl methane diisocyanate, and combinations thereof.

Preferably, the diisocyanate is methylene diphenyl diisocyanate (MDI), naphthalene diisocyanate (NDI), or hexane diisocyanate (HDI).

The polyol, as a compound containing two or more —OH groups therein, binds with diisocyanate to form a urethane bond, and constitutes the soft segment of the thermoplastic polyurethane.

Preferably, the polyol is one selected from the group consisting of polyester polyols, polycarbonate polyols, polyether polyols, and combinations thereof. The number average molecular weight of the polyol may be 500 to 4,000, preferably 1000 to 2,500.

When the number average molecular weight of the polyol is less than 500, the thermoplastic polyurethane may become hard and thus poor flexibility is exhibited. When the number average molecular weight of the polyol is greater than. 4,000, the elongation of the thermoplastic polyurethane may become too high and thus relatively low strength may be exhibited.

The chain extender may include a glycol and may be an aliphatic glycol having a carbon number of 2 to 10. A glycol is a dihydric alcohol including two —OH groups, and binds with diisocyanate to constitute the hard segment.

The chain extender may be one selected from the group consisting of ethylene glycol, propanediol, butanediol, pentanediol, hexanediol, heptanediol, octanediol, decanediol, and combinations thereof. Preferably, the chain extender is butanediol, propanediol, or hexanediol.

A molar ratio of the diisocyanate to the sum of the polyol and the chain extender (diisocyanate/(polyol+chain extender)) may be 1.025 to 1.040. When the molar ratio is less than 1.025, the strength of the thermoplastic polyurethane does not increase. When the molar ratio is greater than 1.040, an excessive reaction occurs and thus a resin gel may be generated.

A molar ratio of the chain extender to the polyol (chain extender/polyol) may be 3.6 to 3.8. When the molar ratio is less than 3.6, the strength of the thermoplastic polyurethane does not increase. When the molar ratio is 3.8 or more, the flexibility of the thermoplastic polyurethane may be decreased.

The mixture of the prepolymer and chain extender may be prepared in paste form by reacting at 80 to 120° C. Preferably, the mixture is reacted for 20 to 30 minutes. When the mixture is reacted at less than 80° C., the thermoplastic polyurethane might not be sufficiently synthesized. When the mixture is reacted at greater than 20° C., a reaction yield may be decreased.

A step of pulverizing a paste, which has been prepared as described above, and then further reacting the pulverized paste in a pelletizing extruder may be further included (S40). Here, the reaction is performed at 200 to 250° C. for 2 to 3 minutes. When the reaction is performed within these temperature and time ranges, the uniformity, stability, and proccessability of a resin extruded from the pelletizing extruder may be maximized.

0.05 to 0.10 parts by weight of carbon nanotubes, relative to 100 parts by weight of the sum of the diisocyanate, the polyol, and the chain extender, may be further added to the paste that has been pulverized by the additional reaction step. The carbon nanotube may be a single-walled carbon nanotube, a multi-walled carbon nanotube, or the like. When the carbon nanotube is added within the above range, the strength of the thermoplastic polyurethane may be maximized.

Next, the resin, which has passed through the pelletizing extruder, is prepared into pellets. A step of selecting a pellet and storing and aging the selected pellet may be further included. The protective member for coil springs 20 according to the present disclosure, i.e., the thermoplastic polyurethane forming the protective member for coil springs 20, may further include an additive. This additive is included to prevent discoloration and property deterioration of thermoplastic polyurethane due to hydrolysis, ultraviolet rays, heat, atmospheric smog, or the like. The additive may further include an antioxidant, a UV stabilizer, a lubricant, a wax, and the like.

A total of the additives may be included in an amount of less than 1.5 parts by weight based on 100 parts by weight of the thermoplastic polyurethane. In particular, an antioxidant may be included in an amount of 0.5 parts by weight or less, a UV stabilizer may be included in an amount of 0.5 parts by weight or less, and a lubricant and a wax may be included in an amount of 0.3 parts by weight or less.

In accordance with another aspect of the present disclosure, the protective member for coil springs 20 manufactured according to the method, particularly the protective member for coil springs 20 made of thermoplastic polyurethane, is provided.

Hereinafter, thermoplastic polyurethane used to manufacture the protective member for coil springs 20 of the present disclosure, particularly the tube main body 21 and the dual tube 26 (27), is described in more detail with reference to the following Examples and Comparative Examples. However, the following Examples and Comparative Examples are not provided to limit the scope of the present disclosure.

### EXAMPLE

### Example 1

8.54 kg of methylene diphenyl diisocyanate and 14.11 kg of a polyester polyol (molecular weight: 2000) were reacted at 90° C. for 20 minutes, thereby preparing a prepolymer. 2.35 kg of butanediol, as a chain extender, was added to the prepared prepolymer and the reaction was allowed at 90° C. for 20 minutes, thereby obtaining a resin paste. This obtained resin paste was pulverized, and reacted and extruded in a 200° C. pelletizing extruder for 2 minutes. Subsequently, a pellet was prepared. As a result, a thermoplastic polyurethane specimen was obtained.

### Example 2

A thermoplastic polyurethane specimen was obtained in the same manner as in Example 1, except that 8.58 kg of methylene diphenyl diisocyanate was used to satisfy a molar ratio summarized in Table 1 below.

### Example 3

A thermoplastic polyurethane specimen was obtained in the same manner as in Example 1, except that 12.52 g of single walled carbon nanotubes was added to a paste pulverized according to Example 1 and the reaction was performed in a pelletizing extruder.

### Example 4

A thermoplastic polyurethane specimen was obtained in the same manner as in Example 1, except that 25.04 g of single-walled carbon nanotubes was added to a paste pulverized according to Example 1 and the reaction was performed in a pelletizing extruder.

### Comparative Example 1

A thermoplastic polyurethane specimen was obtained in the same manner as in Example 1, except that 8.45 kg of methylene diphenyl diisocyanate was used to satisfy a molar ratio summarized in Table 1.

TABLE 1

| | Content | | | | Molar ratio |
|---|---|---|---|---|---|
| | | Chain | Di- | Carbon | Molar ratio |
| | Polyol | extender | isocyanate | nano- | (DI/(PO + |
| | (PO) | (CE) | (DI) | tube | CE)) |
| Comparative | 14.11 kg | 2.35 kg | 8.45 kg | — | 1.019 |
| Example 1 | | | | | |
| Example 1 | 14.11 kg | 2.35 kg | 8.54 kg | — | 1.030 |
| Example 2 | 14.11 kg | 2.35 kg | 8.58 kg | — | 1.034 |
| Example 3 | 14.11 kg | 2.35 kg | 8.54 kg | 12.52 g | 1.030 |
| Example 4 | 14.11 kg | 2.35 kg | 8.54 kg | 25.04 g | 1.030 |

The properties, such as tensile strength, of a thermoplastic polyurethane specimen obtained according to each of the examples and comparative examples were measured and are summarized in Table 2 below and the accompanying FIG. 14.

TABLE 2

| | Tensile strength | Elongation | Strength | |
|---|---|---|---|---|
| | (kgf/cm2) | (%) | (shore A) | Density |
| Comparative | 474 | 695 | 94 | 1.2 |
| Example 1 | | | | |
| Example 1 | 580 | 544 | 94 | 1.2 |
| Example 2 | 663 | 557 | 94 | 1.2 |
| Example 3 | 705 | 540 | 94 | 1.2 |
| Example 4 | 713 | 539 | 94 | 1.2 |

As shown in Table 2 and FIG. 14 it can be confirmed that the tensile strength of thermoplastic polyurethane according to each of the examples used to manufacture the protective member for coil springs 20 of the present disclosure remarkably increases, compared to the tensile strength of thermoplastic polyurethane according to the comparative example.

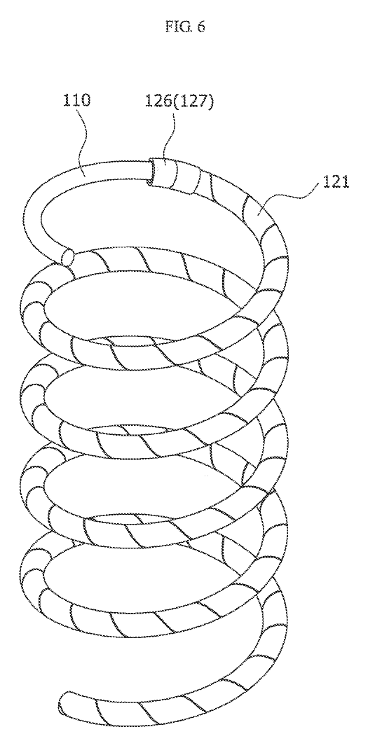

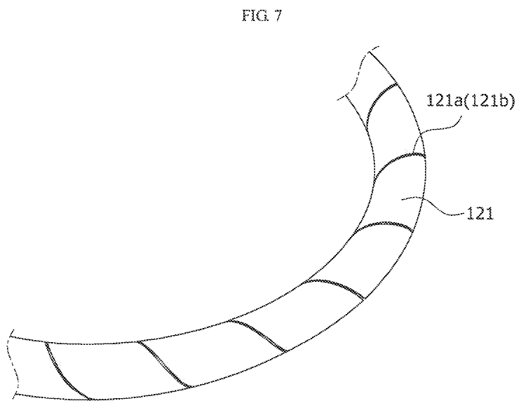

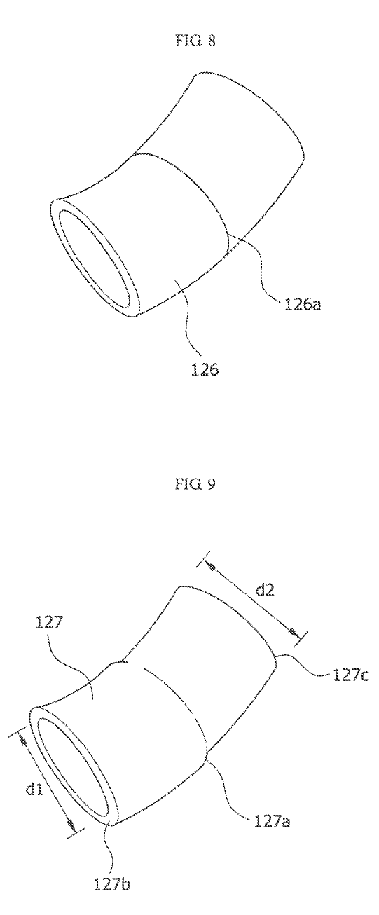

FIG. 5 is a perspective view illustrating a tube main body and a dual tube, which is separated from the tube main body, of a protective member for coil springs according to another embodiment of the present disclosure. FIG. 6 illustrates a state in which a dual tube of a protective member for coil springs according to another embodiment of the present disclosure is mounted. FIG. 7 illustrates a tube main body of a protective member for coil springs according to another embodiment of the present disclosure. FIG. 8 illustrates a first embodiment of a dual tube of a protective member for coil springs according to another embodiment of the present. FIG. 9 illustrates a second embodiment of a dual tube of a protective member for coil springs according to another embodiment of the present disclosure.

Referring to FIGS. 5 to 9, a protective member for coil springs 120 according to another embodiment of the present disclosure is formed in a hollow pipe shape. The protective member for coil springs 120 according to this embodiment includes a tube main body 121 and a dual tube 126 (127).

The tube main body 121 has a hollow pipe shape, and surrounds and covers a coil spring 110 of a suspension for various vehicles.

The dual tube 126 (127) covers the coil spring 110. Particularly, a portion of the dual tube 126 (127) covers the tube main body 121 that covers the coil spring 110, and the remainder of the dual tube 126 (127) covers a portion of the coil spring 110 that is not covered by the tube main, body 121.

In the embodiment, the end 121a of the tube main body 121 is not exposed to the outside because the end 121a is covered by the dual tube 126 (127). Accordingly, the entry of foreign matter, such as soil and water, into a gap between the end 121a of the tube main body 121 and the coil spring 110 may be prevented.

Since the dual tube 126 (127) is made of a shrinkable material as in the tube main body 121, a portion of the dual tube 126 (127) contacts the tube main body 121, and the remainder of the dual tube 126 (127) contacts the coil spring 10. Accordingly, the entry of foreign matter into a gap between the dual tube 126 (127) and the tube main body 121 or a gap between the dual tube 126 (127) and the coil spring 110 may be prevented.

Referring to FIG. 8, a marked part 126a is formed at the center, in a longitudinal direction, of a dual tube 126 according to an embodiment of the present disclosure. The lengths of left and right portions of the dual tube 126 may be the same with respect to the end 121a of the tube main body 121 merely by aligning the marked part 126a of the dual tube 126 with the end 121a of the tube main body 121 when the dual tube 126 is installed.

Since both sides of the dual tube 126, with respect to the end 121a of the tube main body 121, may be blocked, without being biased toward any direction, due to the marked part 126a, the entry of foreign matter into a gap between one end of the dual tube 126 and the tube main body 121 and a gap between the other end of the dual tube 126 and the coil spring 110 may be simultaneously prevented.

Referring to FIG. 9, in another embodiment, ends 127b and 127c of a dual tube 127 have different inner diameters, and a step 127a may be formed at the center of, in a longitudinal direction, the dual tube 127. The end 127b with a larger inner diameter d1 of the dual tube 127 covers the tube main body 121 that covers the coil spring 110, and the end 127c with a smaller inner diameter d2 directly covers the coil spring 110, not the tube main body 121.

Accordingly, the entry of foreign matter into a gap between a left end of the dual tube 127 (see FIG. 9) and the tube main body 121 and a gap between a right end of the dual tube 127 and the coil spring 110 may be simultaneously blocked. Further, in consideration of a thickness difference between a covered portion of the tube main body 121 and a non-covered portion thereof, the dual tube 127 may be more easily installed at the end 121a of the tube main body 121.

Referring to FIG. 10 and FIG. 11, since an inner diameter of one end (left ends in FIGS. 10 and 11) of the tube main body 121 is smaller than an inner diameter of the other end (right end) thereof, when the swelled tube main body 121 is fitted on the cod spring 110 and is dried and shrunk, the tube main body 121 may be fixed at a desired position. That is, when the swelled tube main body 121 is positioned with respect to the end having a smaller inner diameter, the tube main body 121 may be fixed without being largely deviated from the reference position after being dried. In addition, upon manufacturing of the tube main body 121, particularly injection molding of the tube main body 121, the tube main body 121 may be easily demolded.

A ratio of an inner diameter d1 of the end of the tube main body 121 to an inner diameter d2 of the other end thereof may be 1:1.05 to 1:1.25, more particularly 1:1.1 to 1:1.15.

The tube main body 121 may have a tapered pipe shape that has an inner diameter smaller than the cross-sectional diameter of the coil spring 110 so as to protect the coil spring 110. In particular, the smaller inner diameter d1 of the inner diameters d1 and d2 of the tube main body 121 may be the same as or smaller than the cross-sectional diameter of the coil spring 110.

More particularly, the smaller inner diameter d1 of the tube main body 121 may be 0 to 10% smaller than the cross-sectional diameter of the coil spring 110, Since the protective member for coil springs 120 is swelled and then fitted on the coil spring 110, e.g., the protective member is swelled until the inner diameter thereof increases by about 30% and then fitted on the coil spring 110, the protective member for suspension coil springs 120, particularly the inner diameter of the tube main body 121, may be smaller than the cross-sectional diameter of the coil spring 110.

The tube main body 121 may include a plurality of air holes that vertically pass through a peripheral portion thereof. Since the tube main body 121 has a tapered pipe shape, i.e., a shape excluding a cut portion, foreign matter might not easily enter a gap between the tube main body 121 and the coil spring 110 when the tube main body 121 is provided on the coil spring 110. Accordingly, since the possibility of changing or breaking the shape of the tube main body 121 is lowered, the tube main body 121 may be more suitable for protecting the coil spring 110.

Spiral grooves 121a may be formed in an outer surface of the tube main body 121. Since the spiral grooves 121a are formed in the tube main body 121, demolding may be easily performed during injection molding. Accordingly, when the tube main body 121 is swelled and then dried, a drying time may be shortened.

A distance L between the spiral grooves 121a formed in an outer surface of the tube main body 121 may be 10 to 30 mm. In particular, the distance L between the spiral grooves 121a may be 13 to 18 mm. When the distance L between the spiral grooves 121a is within the above range, the tube main body 121 may be dried without being damaged when the tube main body 121 is swelled and then contracted by drying.

A depth H of the spiral grooves 121a formed in an outer surface of the tube main body 121 may be 0.4 to 1 mm. In particular, the depth H of the spiral grooves 121a may be 0.5 to 0.8 mm. When the depth H of the spiral grooves 121a is within the above range, the tube main body 121 may be rapidly dried without being damaged when the tube main body 121 is swelled and then contracted by drying.

The thickness of the tube main body 121 may be 1 to 5 mm, particularly 1.5 to 3 mm. When the thickness of the tube main body 121 is within the above range, the tube main body 121 may protect the coil spring 110 by sufficiently absorbing impact from the outside.

A ratio of the thickness of the tube main body 121 to the depth H of the spiral grooves 121a may be 1:0.2 to 1:0.4, particularly 1:0.25 to 1:0.35. When the ratio of the thickness of the tube main body 121 to the depth H of the spiral grooves 121a is within the above range, the tube main body 121 may be dried without being damaged when the tube main body 121 is swelled and then contracted by drying.

The tube main body 121 may include spiral protrusions 121b, instead of the spiral grooves 121a, on an outer surface thereof. The spiral protrusions 121b may improve the durability of the tube main body 121. In addition, when the tube main body 121 is mounted on the coil spring 110 and the coil spring 110 is contracted, a contact surface between tube main bodies 121 may be reduced, thereby reducing noise. Further, since the spiral protrusions 121b are formed on an outer surface of the tube main body 121, demolding may be easily performed during injection molding, and, when the tube main body 121 is swelled and then dried, a drying time may be shortened.

A distance L between the spiral protrusions 121b formed on an outer surface of the tube main body 121 may be 10 to 30 mm. In particular, the distance L between the spiral protrusions 121b may be 13 to 18 mm. When the distance L between the spiral protrusions 121b is within the above range, the tube main body 121 may be dried without being damaged when the tube maw body 121 is swelled and then contracted by drying.

A height H of the spiral protrusions 121b formed on an outer surface of the tube main body 121 may be 0.4 to 1 mm. In particular, the height H of the spiral protrusions 121b may be 0.5 to 0.8 mm. When the height H of the spiral protrusions 121b is within the above range, the tube main body 121 may be rapidly dried without being damaged when the tube main body 121 is swelled and then contracted by drying.

The thickness of the tube main body 121 may be 1 to 5 mm, particularly 1.5 to 3 mm. When the thickness of the tube main body 121 is within the above range, the tube main body 121 may protect the coil spring 110 by sufficiently absorbing impact from the outside.

A ratio of the thickness of the tube main body 121 to the height H of the spiral protrusions 121b may be 1:0.2 to 1:0.4, particularly 1:0.25 to 1:0.35. When the ratio of the thickness of the tube main body 121 to the height H of the spiral protrusions 121b is within the above range, the tube main body 121 may be dried without being damaged when the tube main body 121 is swelled and then contracted by drying.

As apparent from the above description, the present disclosure provides a protective member for coil springs which is configured to prevent an end of the tube main body from being exposed to the outside and thus prevents the entry of foreign matter into a gap between the tube main body and a coil spring. Accordingly, a decrease in the elasticity of the protective member, particularly the tube main body, due to the entry of foreign matter, may be prevented, and the service time of the protective member may be extended.

In addition, the present disclosure provides a protective member for coil springs made of thermoplastic polyurethane that provides improved mechanical strength by separately reacting reactants in each step and limiting a composition ration of the reactants.

While the present disclosure has been particularly shown and described with reference to exemplary embodiments thereof, it will be understood by those of ordinary skill in the art that various changes in form and details may be made therein without departing from the spirit and scope of the present disclosure as defined by the following claims.

What is claimed is:

1. A protective member for coil springs, comprising a tube main body that covers a coil spring of a suspension, wherein the tube main body is made of thermoplastic polyurethane that comprises a prepolymer and a chain extender, wherein the prepolymer comprises diisocyanate and a polyol, wherein a molar ratio of the diisocyanate to a sum of the polyol and the chain extender (diisocyanate/(polyol+chain extender)) is 1.025 to 1.040 and a molar ratio of the chain extender to the polyol (chain extender/polyol) is 3.6 to 3.8.

2. The protective member according to claim 1, wherein the diisocyanate is selected from the group consisting of methylene diphenyl diisocyanate (MDI), toluene diisocyanate (TDI), dimethyl diphenyl diisocyanate (TODI), naphthalene diisocyanate (NDI), isophorone diisocyanate (IPDI), phenylene diisocyanate, ethylene diisocyanate, butane diisocyanate, hexane diisocyanate (HDI), cyclohexane diisocyanate, dicyclohexyl methane diisocyanate, and combinations thereof.

3. The protective member according to claim 1, wherein the polyol is selected from the group consisting of polyester polyols, polycarbonate polyols, polyether polyols, and combinations thereof.

4. The protective member according to claim 1, wherein the chain extender is selected from the group consisting of ethylene glycol, propanediol, butanediol, pentanediol, hexanediol, heptanediol, octanediol, decanediol, and combinations thereof.

5. The protective member according to claim 1, wherein 0.05 to 0.10 parts by weight of carbon nanotuhes, relative to 100 parts by weight of a sum of the diisocyanate, the polyol, and the chain extender, is further comprised.

6. The protective member according to claim 1, further comprising a dual tube for covering the coil spring, wherein a portion of the dual tube covers the tube main body that covers the coil spring, and a remainder of the dual tube covers a portion of the coil spring that is not covered by the tube main body.

7. The protective member according to claim 6, wherein the dual tube and the tube main body are made of an identical material, and a marked part is formed at a center, in a longitudinal direction, of the dual tube.

8. The protective member according to claim 6, wherein the dual tube and the tube main body are made of an identical material,
both ends of the dual tube have different inner diameters, and a step is formed at a center, in a longitudinal direction, of the dual tube, and
one end of the dual tube having a larger inner diameter covers the tube main body that covers the coil spring, and another end of the dual tube having a smaller inner diameter covers the coil spring that is not covered by the tube main body.

9. The protective member according to claim 6, wherein an inner diameter of one end of the tube main body is smaller than an inner diameter of another end of the tube main body, and a ratio of the inner diameter of the one end to the inner diameter of the other end is 1:1.05 to 1:1.25.

10. A method of manufacturing a protective member for coil springs, the method comprising:
preparing a prepolymer by reacting diisocyanate with a polyol;
adding a chain extender containing a glycol to the prepolymer and mixing the same; and
preparing a paste by reacting a resultant mixture at 80 to 120° C.,
wherein a molar ratio of the diisocyanate to a sum of the polyol and the chain extender (diisocyanate/(polyol+chain extender)) is 1.025 to 1.040, and
a molar ratio of the chain extender to the polyol (chain extender/polyol) is 3.6 to 3.8.

11. The method according to claim 10, further comprising, after the preparing of the paste, pulverizing the paste and additionally reacting the pulverized paste in a 200 to 250° C. pelletizing extruder.

12. The method according to claim 11, wherein 0.05 to 0.10 parts by weight of carbon nanotubes, relative to 100 parts by weight of a sum of the diisocyanate, the polyol, and the chain extender, is added to the additionally reacted paste.

13. The method according to claim 10, wherein the diisocyanate is selected from the group consisting of methylene diphenyl diisocyanate (MDI), toluene diisocyanate (TDI), dimethyl diphenyl diisocyanate (TODI), naphthalene diisocyanate isophorone diisocyanate (IPDI), phenylene diisocyanate, ethylene diisocyanate, butane diisocyanate, hexane diisocyanate (HDI), cyclohexane diisocyanate, dicyclohexyl methane diisocyanate, and combinations thereof.

14. The method according to claim 10, wherein the polyol is selected from the group consisting of polyester polyols, polycarbonate polyols, polyether polyols, and combinations thereof.

15. The method according to claim 10, wherein the chain extender is selected from the group consisting of ethylene glycol, propanediol, heptanediol, pentanediol, hexanediol, heptanediol, octanediol, decanediol, and combinations thereof.

16. A protective member for suspension coil springs manufactured by the method according to claim 10.
